(19) United States
(12) Patent Application Publication
(10) Pub. No.: US 2021/0255042 A1
(43) Pub. Date: Aug. 19, 2021

(54) THERMOGRAPHY METHOD

(71) Applicant: Research Center for Non Destructive Testing GmbH, Linz (AT)

(72) Inventor: Peter Burgholzer, Gallneukirchen (AT)

(21) Appl. No.: 16/613,986

(22) PCT Filed: May 2, 2018
(86) PCT No.: PCT/AT2018/050007

§ 371 Date: Nov. 15, 2019

(30) Foreign Application Priority Data
May 16, 2017 (AT) A50421/2017

(51) Int. Cl. G01J 5/00; H04N 5/225; G06T 3/40; G06T 11/00

(52) U.S. Cl. CPC G01J 5/00; H04N 5/2256; G06T 3/4053; G06T 2211/424; G01J 2005/0077; G01J 2005/0081; G06T 11/006

(57) ABSTRACT

A method is proposed for recording thermal images of a structure (S) to be depicted arranged under a sample surface (P) with a thermal imaging camera (K) recording the sample surface (P), a source (Q) of electromagnetic radiation for illuminating the structure (S) to be depicted and an evaluation unit (A) for evaluating the surface measurement data recorded by the thermal imaging camera (K). In order to improve the depth resolution, it is proposed that the structure to be depicted (S) be illuminated with an unknown structured illumination for improved reconstruction and thus heated, wherein a plurality of images are used for evaluating the structure (S) and the structure (S) is illuminated with a differently structured illumination for each image and in that a non-linear iterative evaluation algorithm is used for calculating the structure (S) to be depicted from the images recorded with the thermal imaging camera (K), which algorithm exploits the thin occupation and the constant location of the heated structure for the differently structured illumination patterns.

### FIELD OF THE INVENTION

The invention relates to a method and a device for recording thermal images of a structure to be depicted and arranged under a sample surface, having a thermal imaging camera recording the sample surface, a source of electromagnetic radiation for illuminating the structure to be depicted and an evaluation unit for evaluating the surface measurement data recorded by the thermal imaging camera.

### DESCRIPTION OF THE PRIOR ART

The use of an infrared camera for recording thermal images enables non-contact and simultaneous temperature measurement of many surface pixels. From these surface measurement data, a structure embedded in a sample, tissue or the like below a surface can be reconstructed and displayed when heated by an excitation pulse. The main disadvantage in the active thermography image is the loss of spatial resolution proportional to the depth below the sample surface. This results in blurred images for deeper structures.

For many imaging techniques, the possible spatial resolution is limited by the width of the point spread function (PSF), i.e. the image of a small object, ideally a point. In acoustics this corresponds to the diffraction limit or in optics to the Abbe limit. Both limits are proportional to the acoustic or optical wavelength. For smaller structures either higher spatial frequencies corresponding to shorter wavelengths, e.g. electrons, or near-field effects can be used. This is often not possible for biomedical and non-destructive imaging because the structures are embedded in a sample or tissue. Therefore, they are not suitable for near-field methods. Higher frequencies are attenuated below the noise level before they can be detected on the surface. Other high-resolution methods are necessary for the representation of such structures.

In their “Theory of High Resolution” Donoho et al. (D. L. Donoho, A. M. Johnstone, J. C. Hoche, and A. S. Stern, J. R. Statist. Soc. B 54, 41 (1992)) showed that high-resolution imaging can overcome such a resolution limit. When the noise is close to zero, the reconstructed image converges to the original object. For diffraction-limited imaging, they showed that nonlinear algorithms that obey a positivity constraint can obtain a high resolution. Already in 1972 Frieden (B. R. Frieden, J. Opt. Soc. Am. 62, 1202 (1972)) showed for a simulated object consisting of two narrow lines, which could not be resolved with a regression calculation according to the principle of the smallest squares, that his nonlinear reconstruction algorithm can resolve and represent the object.

In 1999, five years after its theoretical description, the first high-resolution far-field fluorescence microscopy was realized experimentally with STED microscopy (T. A. Klar and S. W. Hell, Opt. Lett. 24, 954 (1999)). Later, further high-resolution methods such as STORM, PALM or SOFI were developed, all of which exploit the fact that localization of point sources (e.g. activated fluorescent molecules) is possible with a higher accuracy than the width of the PSF.

The structured illumination microscopy (SIM—M. G. Gustafsson, J. Microscopy 198, 82 (2000)) uses several structured patterns as illumination for high-resolution imaging. The physical origin of the resolution increase is a frequency mixture between the frequencies of the illumination and the object frequencies. The high spatial frequencies in the object are transformed by this frequency mixing into the low frequency range given by the Fourier transform of the PSF and can therefore be depicted. Normally, reconstruction algorithms use the knowledge of the illumination patterns of the structured illumination to calculate the images. However, even small errors in the patterns can lead to errors in the final images. Therefore, a blind SIM was proposed where knowledge of the illumination pattern is not necessary. It is assumed that the illumination patterns are positive and their sum is homogeneous (E. Mudry, K. Belkebir, J. Girard, J. Savatier, E. L. Moal, C. Nicoletti, M. Allain, and A. Sentenac, Nat. Photon. 6, 312 (2012)), or additional restrictions such as the same absorption patterns for all illuminations, thin occupation of the functions or requirements for the covariance of the patterns are applied. Recently, two reconstruction algorithms have been proposed using thin occupation and equality of absorption patterns (so-called block sparsity), which have been successfully applied for acoustic resolution in photoacoustic microscopy. The spatial resolution limit given by the acoustic PSF could thus be largely improved by using illumination with unknown granular laser patterns (“speckle patterns”). The reconstruction algorithms used are also valuable for other imaging techniques where diffuse processes confuse high frequency structural information.

Thermographic imaging uses the pure diffusion of heat, sometimes referred to as thermal waves, wherein the structural information of thermal images is much more attenuated at higher image depths than by acoustic attenuation. Thermographic imaging has some advantages over other imaging techniques, e.g. ultrasound imaging. No coupling media such as water are required, and the temperature development of many surface pixels can be measured in parallel and without contact with an infrared camera. The main disadvantage of thermographic imaging is the sharp decrease in spatial resolution proportional to depth, resulting in blurred images for deeper structures.

### SUMMARY OF THE INVENTION

It is the object of the invention to create a method and an associated device for the recording of thermal images which, compared to the prior art, enable a noticeably improved depth resolution with thermal images of measured structures. In particular, structures lying deeper under a surface should also be able to be displayed in a better way.

The invention solves this object with the features of the independent claim 1. Advantageous further developments of the invention are shown in the subclaims.

The invention overcomes the disadvantage, namely the loss of spatial resolution proportional to the depth below the sample surface, and enables higher resolution even for deeper lying structures by using (unknown) structured illumination and a non-linear iterative evaluation algorithm, which reduces the thin occupation (“sparsity”) and the constant location of the heated structures for the various structured illumination patterns (IJOSP algorithm—T. W. Murray, M. Haltmeier, T. Berer, E. Leiss-Holzinger, and P. Burgholzer, Optica 4, 17 (2017).

The unknown structured illumination can be light falling through moving slot diaphragms, as shown in the following example. When coherent light (laser, microwave or the like) is used, dark and bright spots, called laser speckles, are automatically produced in a scattering sample, such as a biological tissue, by interference phenomena, so that the use of a separate diaphragm can be dispensed with if necessary. These speckle patterns are used as unknown structured illumination and the size of the bright areas (speckles) depends on the light wavelength of the laser, the scattering properties of the sample and the penetration depth of the light in the sample.

According to the invention, the effect of the resolution decreasing proportionally with depth can be avoided if a known or unknown structured illumination and a nonlinear reconstruction algorithm are used to reconstruct the embedded structure. This makes it possible, for example, to depict line patterns or star-shaped structures through a 3 mm thick steel sheet with a resolution that is at least significantly better than the width of the thermographic point spread function (PSF). Further details are given in the embodiment example.

According to the invention, in order to avoid the disadvantage of the strong decrease of spatial resolution proportional to the depth of a sample under the sample surface, an unknown structured illumination is used together with an iterative algorithm, which exploits the thin occupation of the structures. The reason for this decrease in resolution with increasing depth is the entropy production during the diffusion of heat, which for macroscopic samples is equal to the loss of information and therefore limits the spatial resolution. The mechanism for the loss of information is thermodynamic fluctuation, which is extremely small for macroscopic samples. However, these fluctuations are highly amplified during the reconstruction of structural information from thermographic data (“badly positioned” inverse problem). The entropy production, which depends only on the mean temperature values, is for macroscopic samples equal to the loss of information caused by these fluctuations. For real heat diffusion processes these fluctuations cannot be described by simple stochastic processes, but for macroscopic samples the information loss depends only on the amplitude of the fluctuations in relation to the mean temperature signals, which corresponds to the signal-to-noise ratio (SNR). With this knowledge it is possible to derive a PSF from the SNR without calculating the information loss and entropy production.

In particular, the thermographic reconstruction is carried out in a three-stage process. In a first step, the measured time-dependent temperature signals Tₛ(r, t) are converted into a virtual acoustic signal as a function of location r and time t (see P. Burgholzer, M. Thor, J. Gruber, and G. Mayr, J. Appl. Phys. 121, 105102 (2017)). In a second step, an ultrasonic reconstruction procedure (e.g. FSAFT) is used to reconstruct y(r) as a space function. In a third step, the space-only IJOSP algorithm, a non-linear iterative algorithm, is used for thermographic reconstruction (T. W. Murray, M. Haltmeier, T. Berer, E. Leiss-Holzinger, and P. Burgholzer, Optica 4, 17 (2017)).

Only as a result of the spatially structured excitation, which is unknown, but statistically changes the measured signals significantly in several measurements, a “super-resolution” spatial resolution can be achieved by the used IJOSP algorithm. Super resolution is the name of this resolution because, analogous to optics, it enables a spatial resolution better than the wavelength (Abbe limit in optics), in this case the wavelength of the so-called “thermal wave”.

### BRIEF DESCRIPTION OF THE INVENTION

In the drawing and in the following embodiment example, the invention is shown by way of example, wherein:

FIG. 1 shows the representation of a point source, its thermographic image in Fourier space and its thermographic image in real space,

FIG. 2 shows a test arrangement for linear structures to be measured,

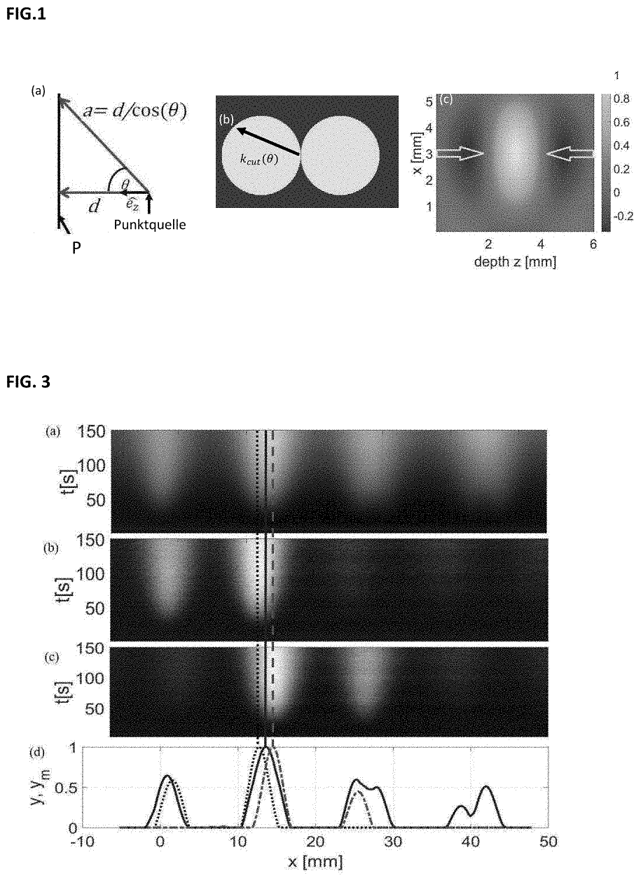

FIG. 3 shows different reconstruction examples of the linear structures,

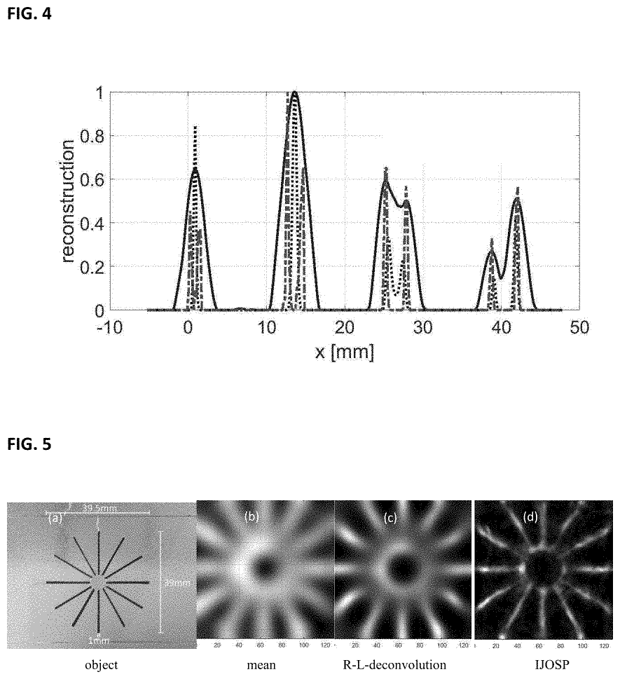

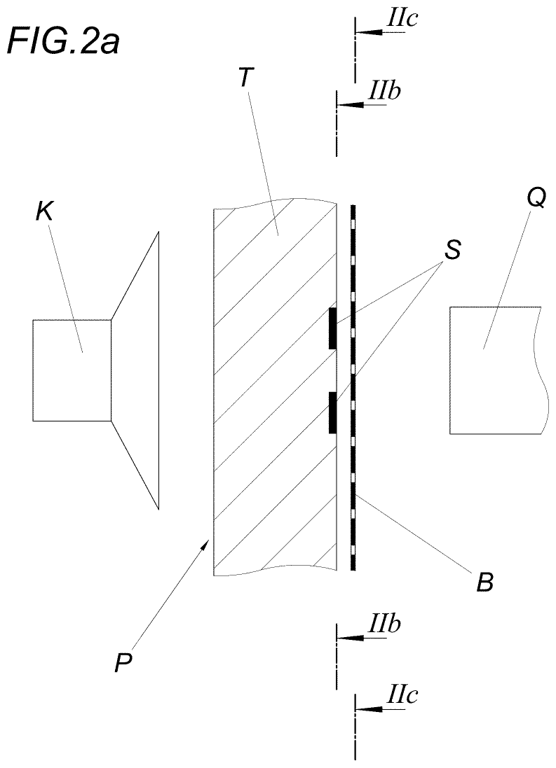

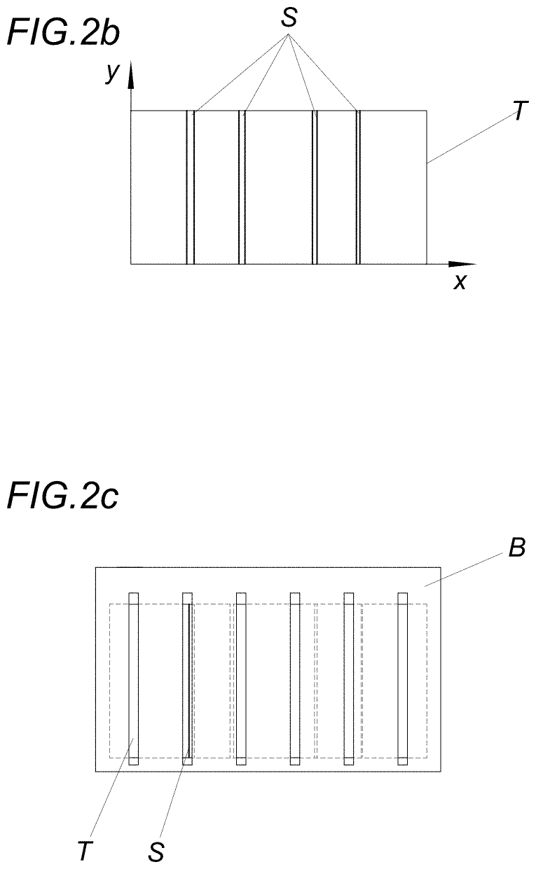

FIG. 4 shows a comparison of the results of different reconstruction examples, FIG. 5 shows reconstruction results for a star-shaped structure, and

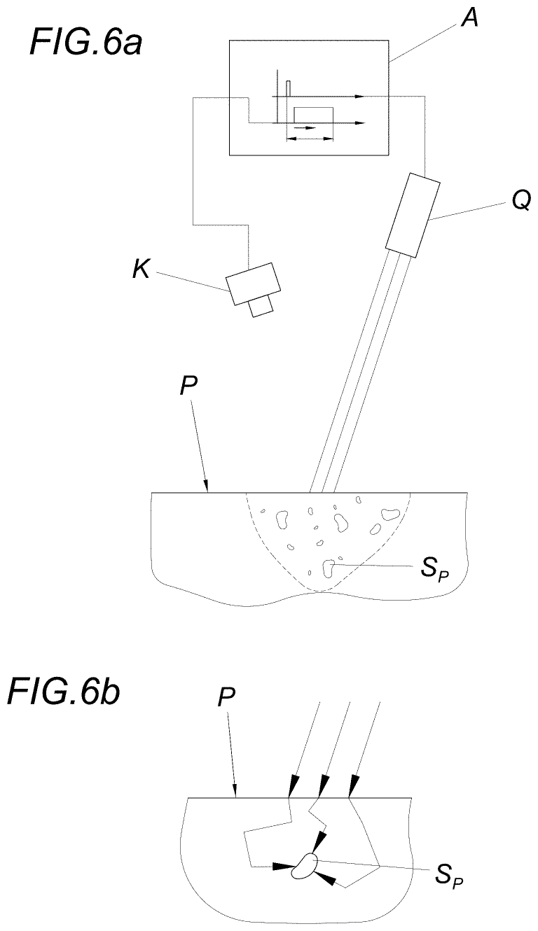

FIG. 6 shows an alternative test arrangement for measuring any three-dimensional structures in a scattering sample.

### DETAILED DESCRIPTION OF THE PREFERRED EMBODIMENT

FIG. 1(a) shows a point source at a depth d with unit vector (e_{z}) perpendicular to the surface plane: The length a of the thermal wave reaching the surface plane depends on the angle θ. FIG. 1(b) shows a two-dimensional (or a cross-section of a three-dimensional) PSF in the Fourier space. Up to k_{cut}(θ) (eq. 5) the value of the PSF is one and above k_{cut} zero. Parallel to the detection surface (θ=90°), the length a becomes infinite, which is why no thermal waves can reach the surface in this direction. FIG. 1(c) shows the two-dimensional PSF in real space. The lateral resolution (vertical direction) is 2.44 times the axial resolution (horizontal direction). The axial resolution (horizontal arrows) for pulsed thermography is limited by kₒᵤₜ and is therefore proportional to the depth d, divided by the natural logarithm of the SNR.

FIG. 2a shows a device for recording thermal images of a structure S arranged under a sample surface P, having a thermal imaging camera K for recording the sample surface P, having a source Q of electromagnetic radiation for illuminating the structure S and having an evaluation unit A for evaluating the surface measurement data recorded by the thermal imaging camera K, wherein the thermal imaging camera K is directed towards the sample surface P in such a way that it receives thermal images of the structure S to be depicted which is arranged under a sample surface P and that the source Q of electromagnetic radiation for illuminating the structure S is arranged on the side of the sample surface P opposite the thermal imaging camera K and is directed towards the structure S to be depicted. A diaphragm B is arranged between source Q and structure S for the structured illumination of the structure S, wherein the diaphragm B is guided displaceably relative to the structure S, in the present case parallel displaceably relative to the sample surface P.

Structure S is applied to the back of a 3 mm steel plate. In FIG. 2(b), four pairs of lines running in the y-direction are used as light-absorbing patterns. The distance between the lines (from left to right) is 2 mm, 1.3 mm, 0.9 mm and 0.6 mm for a line width of 1 mm. In order to produce a structured illumination (FIG. 2(c)), slots were cut into an aluminum foil acting as a diaphragm B at a distance of 10 mm, wherein the slots have a width of 1 mm and run parallel to the absorption lines. Through these slots, the flashlight can stimulate the surface of the back of the steel sheet with energy. An infrared camera (frame rate 800 Hz, 320×32 pixels, 6 pixels per mm) on the front of the steel plate measures the surface temperature development. After each measurement, the slot mask is moved in the x-direction with a step width of 0.2 mm. In the embodiment example, 55 measurements are used to reconstruct the positions of the absorbing line pairs from the captured images.

FIG. 3 shows a two-dimensional reconstruction example (for the parallel line pairs mentioned above). Fig3(a) represents an average signal Tₛ(x,t) of all speckle patterns equal to the measured signal without the slot mask. FIGS. 3(b) and (c) represent the measured surface temperature Tₛ(x,t) for illumination with two different speckle patterns. FIG. 3(d) shows the thermographic reconstructions yₘ(x) for the two different illumination patterns (FIG. 3(b) and (c) m=10 (dotted) and m=19 (dashed dotted)), as well as the reconstruction of the mean value y(x) (solid line) shown in FIG. 3(a). The vertical lines between FIGS. 3(a) to (d) show the displacement of the maximum for the individual speckle patterns, which subsequently allow the high-resolution reconstruction of the line positions.

FIG. 4 shows a mean value reconstruction (bold), an R-L (Richardson-Lucy) deconvolution (dotted), and an iterative reconstruction (IJOSP, dashed dotted).

FIG. 5 shows reconstruction results using a two-dimensional star-shaped sample with 165 illumination patterns, 55 illumination patterns with slots running in the y-direction and 55 illumination patterns each with slots running in the ±45° direction. FIG. 5(a) —the object is a star-shaped sample consisting of 12 lines, each approx. 1 mm thick. The reconstructed objects were calculated in FIG. 5(b) from the mean temperature signal, in FIG. 5(c) with the R-L (Richardson Lucy) deconvolution and in FIG. (d) with the iterative reconstruction (IJOSP). The pixel size was 0.21 mm, resulting in 4.75 pixels of 1 mm each and a total of 128×128 pixels. The camera frame rate was 500 Hz.

FIG. 6a and the enlarged detail of the scattering sample thereof in FIG. 6b show a device for recording thermal images of a structure S arranged under a sample surface P, having a thermal imaging camera K for recording the sample surface P, having a coherent source Q of electromagnetic radiation for illuminating the structure S and having an evaluation unit A for evaluating the surface measurement data recorded by the thermal imaging camera K, wherein the thermal imaging camera K is directed towards the sample surface P in such a way that it receives thermal images of the structure S to be depicted which is arranged under a sample surface P and that the source Q of electromagnetic radiation for illuminating the structure S is arranged on the same side as the thermal imaging camera K with respect to the sample surface P and is directed towards the structure S to be depicted. In the evaluation unit, two superimposed diagrams indicate the actuation of the thermal imaging camera K and the source Q, a pulsed laser or a pulsed microwave source. First a short excitation pulse is emitted, after which the thermal imaging camera records a sequence of images for a given time interval (if necessary at the same time). This process is repeated several times, wherein it is essential that the speckle pattern formed by interference of the coherent electromagnetic radiation inside the scattering sample changes from pulse to pulse (unknown structured illumination). In living biological tissue this occurs by slight movement automatically. For other samples (e.g. plastics), the change in the speckle pattern from one pulse to the next can be caused by a slight movement of the sample or source (rotation or displacement).

### Embodiment Example

In order to derive the thermographic PSF, the damping of a one-dimensional thermal wave is treated first.

T(z, t)=Real(T₀e^{i(σz-ωt)}), (1

where T(z,t) is the temperature as a function of the depth z of the sample and the time t, T₀ is a complex constant to satisfy the boundary condition at the surface with z=0, σ is the complex wave number and w=2πf corresponds to the thermal wave frequency.

This solves the heat diffusion equation

$$( {∇}^{2} - \frac{1}{α} \frac{\partial }{\partial t} ) T ( z , t ) = 0 , mit σ = \sqrt{\frac{i ω}{α}} ≡ \frac{1 + i}{μ} , \qquad ( 2 )$$

where ∇² is the Laplace operator, i.e. the second derivative in space, α is the material-dependent thermal diffusion coefficient assumed to be homogeneous in the sample, and μ≡\sqrt{2α/ω} is defined as a thermal diffusion length where the amplitude of the thermal wave is reduced by a factor of 1/e. This results in eq. (1) as follows:

$$T ( z , t ) = R eal ( {T}_{0} {e}^{- \frac{z}{μ}} exp ( i \frac{z}{μ} - i ω t ) ) , \qquad ( 3 )$$

which describes an exponentially damped wave in z with the wave number or spatial frequency k≡1/μ. The cut-off wave number k_{cut}, at which the signal for a depth z=a is attenuated to the noise level, results from equation (3) to form:

$$exp ( - {k}_{c u t} a ) = \frac{1}{SNR} ⇒ {k}_{c u t} = \frac{lnSNR}{a} \qquad ( 4 )$$

A higher spatial frequency than k_{cut} cannot be resolved, since the signal amplitude falls below the noise level at a distance a. The same result can be derived for one-dimensional heat diffusion by setting the information loss equal to the mean entropy production. In order to obtain a two- or three-dimensional thermographic PSF, a point source is embedded in a homogeneous sample at a depth d related to a flat measuring surface. The distance a to the surface depends on the angle θ (FIG. 1(a)):

$${k}_{c u t} ( θ ) = \frac{lnSNR}{a} = \frac{lnSNR}{d} cos ( θ ) \qquad ( 5 )$$

FIG. 1(b) shows a two-dimensional PSF or a cross-section of a three-dimensional thermographic PSF in the Fourier space. In all directions up to k_{cut}(θ) the value of the PSF is one and above kₒᵤₜ zero.

For a selected test arrangement (see FIG. 2), the depth d=3 mm (=thickness of a steel sheet) and the effective SNR=2580. FIG. 1(c) shows the two-dimensional thermographic PSF calculated for this purpose in real space, which corresponds to the inverse Fourier transformation from FIG. 1(b), calculated by the two-dimensional inverse Fourier transformation. The axial depth resolution is limited by kₒᵤₜ=2.62 mm⁻¹ from equation (5) at θ=0, which is the same as in the one-dimensional case according to equation (4). The zero points at a depth z=d±π/k_{cut}=3 mm±1.2 mm are represented by two horizontal arrows in FIG. 1(c), resulting in an axial resolution of 2.4 mm. The lateral resolution (5.85 mm vertical direction in FIG. 1(c)) is 2.44 times the axial resolution.

The lateral resolution of this PSF is used in the following for deconvolution or for the IJOSP reconstruction algorithm, which enables high resolution. The same PSF can be reconstructed from a point source using a two-step image reconstruction method. First, the measured signal is converted into virtual acoustic waves (see P. Burgholzer, M. Thor, J. Gruber, and G. Mayr, J. Appl. Phys. 121, 105102 (2017)), according to which any available ultrasonic reconstruction technique, such as the synthetic aperture focusing technique (F-SAFT), is used for the reconstruction. This method only produces a meaningful PSF if the measurement time is sufficient to measure the signals up to θ≈45° and use them for reconstruction. For shorter measuring times, only a small cone of the PSF in the Fourier space has the value one in the axial direction and the rest has the value zero. In real space, the axial resolution remains almost constant for shorter measurement times, while the lateral resolution becomes worse.

An experimental setup to illustrate this method according to the invention for high-resolution thermographic imaging comprises the following. A 3 mm thick steel sheet (standard structural steel with a thermal diffusivity of 16 mm²s⁻¹) was blackened on both sides for improved heat absorption and dissipation. An absorbent pattern, such as parallel lines or a star, was created on the back of the steel sheet using an aluminum foil acting as a reflective mask. This ensures that only the unmasked (black) patterns absorb light from an optical flash arrangement irradiating this side (Blaesing P B G 6000 with 6 kJ electrical energy). An infrared camera (Ircam Equus 81k M Pro) was used to measure the temperature curve on the front side of the steel sheet. A three-dimensional thermographic imaging method is used for this purpose (P. Burgholzer, M. Thor, J. Gruber, and G. Mayr, J. Appl. Phys. 121, 105102 (2017)), whereby the image y (r) can be reconstructed as space function r of the absorbing pattern, wherein the folding of the absorbed light I(r) ρ(r) takes place with the thermographic PSF h (r) shown in FIG. 1(c):

$$y ( r ) = h ( r ) * [ I ( r ) \cdot ρ ( r ) ] + ɛ ( r ) ≡ \int h ( r - {r}^{′} ) I ( {r}^{′} ) ρ ( {r}^{′} ) {dr}^{′} + ɛ ( r ) , \qquad ( 6 )$$

wherein ε (r) indicates the noise (error) in the data, ρ (r) indicates the optical absorption of the absorbing patterns, and I (r) is the illuminating luminous flux. The spatial variable r for the line pair patterns is described as a one-dimensional coordinate on the steel surface perpendicular to the lines (x-direction), and for two-dimensional patterns, such as a star, the two-dimensional Cartesian coordinate pair (x- and y-direction) is described on the back of the steel sheet.

In the first embodiment example (FIG. 2), four parallel lines were used as an absorbent pattern on the 3 mm thick steel sheet with a spacing of 2 mm, 1.3 mm, 0.9 mm and 0.6 mm and a thickness of 1 mm (FIG. 2(a)). For structured illumination, 1 mm wide slots were cut into an aluminum foil at a distance of 10 mm each and this slot mask was moved perpendicular to the lines in x-direction with a step width of 0.2 mm. The use of at least M=55 different illumination patterns I₁, I₂, . . . , I_{M} ensures the illumination of all absorption lines in this embodiment example. The illumination patterns and the absorber distribution are represented by discrete vectors Iₘ, ρ∈R^{N}, wherein the N-components denote the pixel values of the camera at equidistant points. According to equation (6), the measured signal from the focused transducer is

yₘ=h*[Iₘ·ρ]+ϵₘ for m=1, . . . , M (7)

The aim is to calculate the absorber distribution p and, to a certain extent, the illumination pattern Iₘ from the data. The product Hₘ≡Iₘ·ρ corresponds to the heat source assigned to the m^{th} speckle pattern. The heat sources Hₘ are (theoretically) clearly determined by the deconvolution equations (7). However, due to the poorly conditioned deconvolution with a smooth core, these uncoupled equations are error-sensitive and only provide low-resolution reconstructions if they are solved independently and without appropriate regularization. In order to obtain high-resolution reconstructions, it is proposed according to the invention to use a reconstruction algorithm which takes advantage of the fact that all Hₘ come from the same density distribution ρ, which are also sparse, called IJOSP (iterative joint sparsity) algorithm.

Numerically this can be implemented by the following minimization

$$F ( H ) = \frac{1}{2} {\sum }_{m = 1}^{M} {\sum }_{i = 1}^{N} {\vert h * {H}_{m} ( {x}_{i} ) - {y}_{m} ( {x}_{i} ) \vert}^{2} + {α}_{1} {‖ H ‖}_{2 , 1} + \frac{{α}_{2}}{2} {‖ H ‖}_{2}^{2} \to {min}_{H} \qquad ( 8 )$$

with the FISTA (Fast Iterative Threshold Algorithm—A. Beck and M. Teboulle “A Fast Iterative Shrinkage-Thresholding Algorithm for Linear Inverse Problems,” SIAM J. Imaging Sci. 2, 183-202 (2009)). The first term in equation (8) is the data adaptation term, the second term uses the thin occupation and equality of the density distribution ρ and the last term is a stability term known from the Tikhonov regulation for general inverse problems. As with other regulatory methods, α₁ and α₂ are regulatory parameters that must be adequately selected for the results presented in FIG. 4 (α₁=10⁻² and α₂=5*10⁻⁴). The term generating the thin occupation and equality of the density distribution ρ

∥H∥_{2,1}≡Σᵢ₌₁^{N}\sqrt{Σₘ₌₁^{M}|Hₘ(xᵢ)|²} (9)

provides solutions with minimization, which prefer thin occupation and equality of density distribution ρ. First, for each individual pixel measured, the l²-norm is taken over all M different illumination patterns and then these positive values are summed up (N pixels). This term favors blocked thin solutions, which means that it has a lower value for solutions that deviate from zero only in a few places, but becomes even lower if these entries are not equal to zero for all illumination patterns in the same place.

In the following, the measurement and reconstruction results for the four absorbing line pairs are presented.

FIG. 3(a) shows the measured surface temperature Tₛ(x, t) without using the slot mask at time t. Since the thickness of the steel sheet (3 mm) is short compared to the length of the line pairs (47 mm), the problem can be reduced to a two-dimensional heat diffusion problem. In the y-direction, parallel to the line pairs, the mean value is recorded over 32 camera pixels in this embodiment example to improve the SNR by a factor √32 from about 25.5 to 144 for Tₛ(x, t). FIG. 3(b) and (c) show Tₛ(x, t) for two different illumination patterns. FIG. 3(d) shows the corresponding two-dimensional thermographic reconstruction yₘ(x), for the two different illumination patterns m=10 and m=19 in FIG. 3(b) and (c), respectively, and the reconstruction y(x) for the mean value in FIG. 3(a). For proper functioning of the IJOSP reconstruction algorithm, it is necessary that these reconstructions vary for different illumination patterns. The effective SNR is increased by the two-dimensional thermographic reconstruction by a factor equal to the square root of the pixels used. In x-direction 320 camera pixels were used, 6 pixels for 1 mm on the steel sheet. Therefore, the effective SNR is about 2580, which results in the thermographic PSF shown in FIG. 1(c) at a depth of 3 mm.

FIG. 4 shows the reconstructions from the mean value signal of all speckle patterns corresponding to the reconstructed signal without the slot mask. A Richardson-Lucy (R-L) deconvolution of this signal using lateral thermographic PSF and IJOSP reconstruction is compared. The IJOSP allows to resolve all line pairs, even the one with a distance of only 0.6 mm, while the Richardson-Lucy (R-L) deconvolution of the mean signal can only resolve the two line pairs with a distance of 1.3 mm and 2 mm.

FIG. 5 shows the same reconstruction results for a two-dimensional star-shaped structure instead of parallel line pairs. For the creation of the individual illumination patterns, the slots of diaphragm B were not only aligned in the y-direction, but also inclined by ±45° in the x-y-plane. With 55 illumination patterns per slot orientation, this results in 165 illumination patterns for the two-dimensional star-shaped structure.

In summary, the resolution for the line pairs could be improved from 6 mm lateral resolution (FIG. 1(c)) of the PSF to less than 1.6 mm (1 mm line width and 0.6 mm line spacing) with the help of the IJOSP algorithm, resulting in an improvement of the resolution by approximately a factor of four. How is such a resolution possible if the information transport through the steel sheet is limited by entropy production? The theoretical framework of high-resolution is closely linked to the theory of data compression, which exploits the inherent thin occupation of natural objects in a suitable mathematical basis. The amount of information that is transported through the steel sheet for a structured illumination is the same as for a homogeneous illumination and the solution of the linear inverse equation (6). Frequency mixing of the illumination frequencies shifts the higher spatial frequencies of the object downwards. For the reconstruction, the illumination is either known (SIM) or additional information about the depicted structure, including non-negativity or thin occupation, is exploited (blind SIM). For thermographic imaging, the thin occupation is often a good assumption even in real space, even without using a representation in another base. Cracks or pores are often distributed thinly in the sample volume.

For comparison, the line pattern p was calculated from equation (7) using the least squares method, taking into account known illumination patterns. The results for known illumination patterns were no better than the results for unknown patterns using IJOSP. In addition, three-dimensional high-resolution thermographic imaging is also possible using, for example, speckle patterns for illumination, in which the PSF is not evenly distributed over the region depicted, but increases with depth.

A light-scattering sample, for example biological tissue (FIGS. 6a, b), is illuminated with a laser whose light penetrates the tissue and is scattered. The laser pulse creates bright and dark areas (laser speckles) through interference of the scattered light. The size of these speckles depends on the light wavelength, the scattering properties of the sample and the depth of the penetrating light. These speckle patterns unknown inside the sample are the unknown structured illumination that is absorbed at certain structures, e.g. blood vessels in the tissue, and thus becomes a source of heat. By many such speckle patterns and their evaluation with the IJOSP algorithm the light absorbing structure, e.g. the blood vessels, can be reconstructed from the infrared images of the surface with high resolution.

For the thermographic reconstruction, measured time-dependent temperature signals Tₛ(r, t), which use H(r, t), can also be used directly instead of the PSF h(r) from equation (6), whereby H then also includes the temporal temperature course of the heat diffusion.

1. A method for recording thermal images of a structure to be depicted that is arranged below a sample surface with a thermal imaging camera that records surface measurement data for the sample surface, a source of electromagnetic radiation illuminating the structure to be depicted and an evaluation unit evaluating the surface measurement data recorded by the thermal imaging camera, said method comprising
illuminating the structure to be depicted so as to provide reconstruction with a structured illumination and so that the structure is heated,
recording a plurality of images wherein the structure is illuminated with a different pattern of the structured illumination for each image, and
calculating, using a non-linear iterative evaluation algorithm, the structure to be depicted from the images recorded with the thermal imaging camera, wherein said algorithm uses thin occupation and a constant location of the heated structure for the different patterns of the structured illumination pattern.

2. A method according to claim 1, wherein time-dependent temperature signals are measured with the thermal imaging camera for pixels, and the time-dependent temperature signals for each pixel are converted into a virtual acoustic signal.

3. A method according to claim 2, wherein, in a subsequent step, an ultrasonic reconstruction method is used to reconstruct a spatial function y(r) of the structure from the virtual acoustic signal.

4. A method according to claim 3, wherein, in a further subsequent step,. an DOSP algorithm requiring a point response is used for a thermographic reconstruction of the structure.

5. A method according to claim 4, wherein, for each image taken by the thermal imaging camera, a point response is derived from a signal-to-noise ratio and a distance of the structure to be depicted from a surface, wherein frequencies of signal amplitudes of the point response falling below the signal-to-noise level are set to zero.

6. A method according to claim 4, wherein the point response is determined from the reconstruction of a small punctiform structure at a certain depth.

7. A method according to claim 1, wherein the source of electromagnetic radiation is a coherent light source, a laser or a microwave.

8. A method according to claim 1, wherein the source of electromagnetic radiation is a non-coherent light source which illuminates the structure to be depicted via a diaphragm and wherein different diaphragm settings per image ensure the differently structured illumination per image.

9. A device for recording thermal images of a structure arranged under a sample surface, said device comprising:
a thermal imaging camera recording the sample surface,
a source of electromagnetic radiation illuminating the structure and an evaluation unit evaluating the surface measurement data recorded by the thermal imaging camera,
wherein the evaluation unit operates according to a method comprising calculating, using a non-linear iterative evaluation algorithm, the structure from images of the sample surface recorded with the thermal imaging camera, wherein said algorithm uses thin occupation and a constant location of the structure heated by the electromagnetic radiation for different patterns of the structured illumination.

10. A device according to claim 9, wherein the thermal imaging camera is directed towards the sample surface in such a way that said thermal camera receives thermal images of the structure to be depicted arranged under a sample surface and wherein the source of electromagnetic radiation illuminating the structure is arranged on the side of the sample surface opposite the thermal imaging camera and is directed towards the structure to be depicted.

11. A device according to claim 10, wherein a diaphragm is arranged between the source and the structure so as to provide structured illumination of the structure, wherein the diaphragm is displaceably guided relative to the structure.

12. A device according to claim 9, wherein the thermal imaging camera is directed towards the sample surface in such a way that said thermal camera receives thermal images of the structure to be depicted arranged under the sample surface and wherein the source of electromagnetic radiation illuminating the structure is arranged on the same side as the thermal imaging camera relative to the sample surface and is directed towards the structure to be depicted.

13. A device according to claim 9, wherein time-dependent temperature signals are measured with the thermal imaging camera for pixels, and said evaluation unit converts the time-dependent temperature signals for each pixel into a virtual acoustic signal.

14. A device according to claim 13, wherein said evaluation unit uses an ultrasonic reconstruction method to reconstruct a spatial function y(r) of the structure from the virtual acoustic signal.

15. A device according to claim 14, wherein said evaluation unit uses an IJOSP algorithm requiring a point response for a thermographic reconstruction of the structure.

16. A device according to claim 15, wherein said evaluation unit derives, for each image taken by the thermal imaging camera, a point response from a signal-to-noise ratio and a distance of the structure to be depicted from a surface, wherein frequencies of signal amplitudes of the point response falling below the signal-to-noise level are set to zero.
